(19) United States
(12) Patent Application Publication
(10) Pub. No.: US 2025/0107476 A1
(43) Pub. Date: Apr. 3, 2025

(54) SYSTEMS AND METHODS FOR AN AGRICULTURAL IMPLEMENT

(71) Applicant: CNH Industrial America LLC, New Holland, PA (US)

(72) Inventor: Brittany Schroeder, Bunker Hill, IN (US)

(21) Appl. No.: 18/476,730

(22) Filed: Sep. 28, 2023

(51) Int. Cl. A01B 63/00; A01B 63/24

(52) U.S. Cl. CPC A01B 63/002; A01B 63/24

(57) ABSTRACT

An agricultural system can include an implement including a frame assembly. One or more ground-engaging tools can be operably supported by the frame assembly. An implement actuator can be operably coupled with the frame assembly and configured to alter an implement actuator model relative to a ground surface. A computing system can be communicatively coupled to the implement actuator. The computing system can include a processor and associated memory. The memory can store instructions that, when implemented by the processor, configure the computing system to receive data indicative of residue size, determine an implement levelness based at least partially on the residue size, and determine an implement actuator model based at least partially on the implement levelness.

### FIELD OF THE INVENTION

The present subject matter relates generally to tillage implements that may be operated within an agricultural field.

### BACKGROUND OF THE INVENTION

In some cases, to increase agricultural performance from a field, a farmer may cultivate the soil, typically through a tillage operation. For instance, tillage operations may be performed by pulling a tillage implement behind an agricultural work vehicle, such as a tractor. Tillage implements can include one or more ground-engaging tools configured to engage the soil as the implement is moved across the field. For example, in certain configurations, the implement may include one or more harrow discs, leveling discs, rolling baskets, shanks, tines, and/or the like. Such ground-engaging tool(s) loosen and/or otherwise agitate the soil to prepare the field for subsequent planting operations.

During tillage operations, various amounts of residue may cause negative effects on the tillage operation. Accordingly, an improved system and method for mitigating any negative effects would be welcomed in the technology.

### BRIEF DESCRIPTION OF THE INVENTION

Aspects and advantages of the technology will be set forth in part in the following description, or may be obvious from the description, or may be learned through practice of the technology.

In some aspects, the present subject matter is directed to an agricultural system that includes an implement including a frame assembly and one or more ground-engaging tools operably supported by the frame assembly. An implement actuator is operably coupled with the frame assembly and is configured to alter a position of one or more frame members of the frame assembly relative to a ground surface. A computing system is communicatively coupled to the implement actuator. The computing system includes a processor and associated memory. The memory stores instructions that, when implemented by the processor, configure the computing system to receive data indicative of residue size, determine an implement levelness based at least partially on the residue size, and determine an implement actuator model based at least partially on the implement levelness.

In some aspects, the present subject matter is directed to a method for operating an agricultural system. The method includes receiving, from one or more field sensors, data indicative of residue size. The method also includes determining, with a computing system, an implement levelness based at least partially on the residue size. Lastly, the method includes determining, with a computing system, an implement actuator model based at least partially on the implement levelness.

In some aspects, the present subject matter is directed to an agricultural system that includes a frame assembly and one or more ground-engaging tools operably supported by the frame assembly. An implement actuator is operably coupled with the frame assembly and is configured to alter a position of one or more frame members of the frame assembly relative to a ground surface. A computing system is communicatively coupled to the implement actuator. The computing system includes a processor and associated memory. The memory stores instructions that, when implemented by the processor, configure the computing system to receive data indicative of a size distribution of residue, determine an implement levelness based at least partially on the size distribution of the residue, and determine an implement actuator model based at least partially on the implement levelness.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a front perspective view of an agricultural machine in accordance with aspects of the present subject matter;

FIG. 2 illustrates a front perspective view of an agricultural implement in accordance with aspects of the present subject matter;

FIG. 3 illustrates a side view of a system for an agricultural machine in accordance with aspects of the present subject matter;

FIG. 4 illustrates a side view of a system for an agricultural machine in accordance with aspects of the present subject matter;

FIG. 5 illustrates a block diagram of components of a system for an agricultural machine in accordance with aspects of the present subject matter;

FIG. 6 illustrates various components of a block diagram of some of the components of the system for an agricultural machine in accordance with aspects of the present subject matter; and

FIG. 7 illustrates a flow diagram of a method for operating an agricultural system in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield still a further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based at least partially on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to agricultural systems and methods for operating the agricultural systems that may incorporate a tillage implement. In some cases, the agricultural system includes an implement including a frame assembly. One or more ground-engaging tools can be operably supported by the frame assembly. An implement actuator can be operably coupled with the frame assembly and configured to alter a position of one or more frame members of the frame assembly relative to a ground surface.

A computing system can be communicatively coupled to the implement actuator. The computing system can include a processor and associated memory. The memory stores instructions that, when implemented by the processor, can configure the computing system to receive data indicative of residue size, determine an implement levelness based at least partially on the residue size, and determine an implement actuator model based at least partially on the implement levelness. As used herein, the implement actuator model defines a position of the one or more implement actuators, in order for the frame assembly to be placed at the defined implement levelness.

In various examples, the implement levelness may be compared to a levelness range defined by a lower threshold and an upper threshold, which may be set to mitigate seedbed levelness issues and/or for any other purpose. In some instances, the system may compare the implement levelness to the levelness range to ensure that the defined implement levelness does not exceed the limits for seedbed floor levelness. In some cases, when the determined implement levelness is within the levelness range, the system can define an implement actuator model that correlates to the implement levelness and, in turn, actuate the one or more implement actuators to modify the position of one or more components of the frame assembly (e.g., an angle and position of the implement relative to the ground and/or the vehicle) based on the implement actuator model. When the determined implement levelness deviates from the levelness range, the implement actuator model is set to a maximum offset angle when the implement actuator model exceeds an upper threshold of the defined levelness range. Likewise, the system can set the implement actuator model to a minimum offset angle when the implement actuator model is less than a lower threshold of the defined levelness range. In addition, the system can continue to observe the potential for/of plugging of the implement based at least partially on the frame being placed in the implement actuator model.

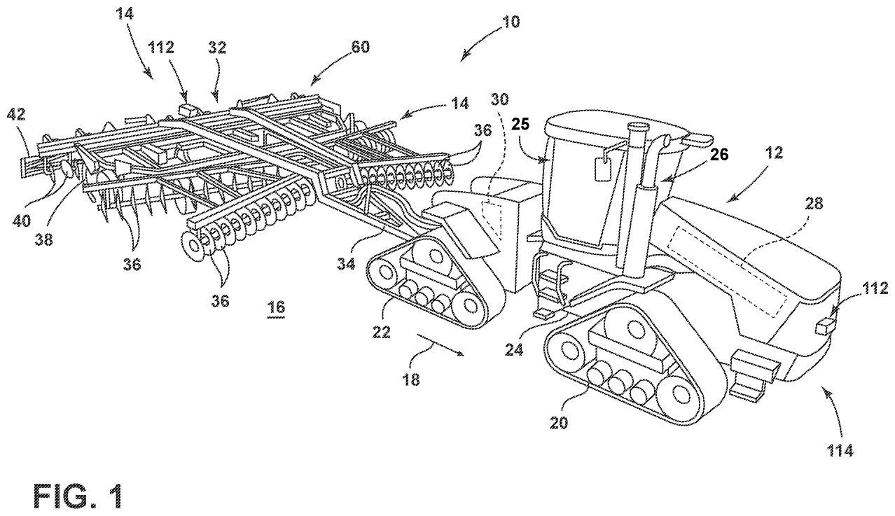

Referring now to drawings, FIGS. 1-4 illustrate an agricultural machine 10 that can include a work vehicle 12 and an associated agricultural implement 14. In general, the work vehicle 12 is configured to tow the implement 14 across a field 16 in a direction of travel (e.g., as indicated by arrow 18 in FIG. 1). In the illustrated examples, the work vehicle 12 is configured as an agricultural tractor and the implement 14 is configured as an associated tillage implement. However, in other embodiments, the work vehicle 12 may be configured as any other suitable type of vehicle, such as an agricultural harvester, a self-propelled sprayer, and/or the like. Similarly, the implement 14 may be configured as any other suitable type of implement, such as a planter. Furthermore, the agricultural machine 10 may correspond to any suitable powered and/or unpowered agricultural machine 10 (including suitable vehicles and/or equipment, such as only a work vehicle or only an implement). Additionally, the agricultural machine 10 may include two or more associated vehicles, implements, and/or the like (e.g., a tractor, a planter, and an associated air cart).

As shown in FIG. 1, the work vehicle 12 includes a pair of front track assemblies 20, a pair of rear track assemblies 22, and a frame or chassis 24 coupled to and supported by the track assemblies 20, 22. An operator's cab 25 may be supported by a portion of the chassis 24 and may house various input devices 26 for permitting an operator to control the operation of one or more components of the work vehicle 12 and/or one or more components of the implement 14. Additionally, the work vehicle 12 may include a power source 30 and a transmission 32 mounted on the chassis 24. The transmission 32 may be operably coupled to the power source 30 and may provide variably adjusted gear ratios for transferring power to the track assemblies 20, 22 via a drive axle assembly (or via axles if multiple drive axles are employed).

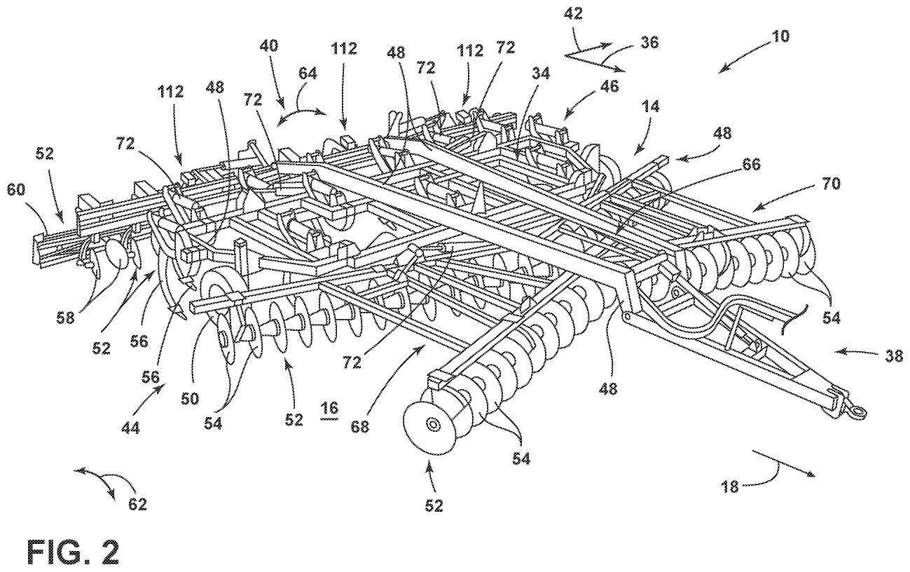

Additionally, as shown in FIG. 2, the implement 14 may generally include a frame assembly 34 configured to be towed by the work vehicle 12 via a pull hitch or tow bar in the direction of travel 18 of the vehicle 12. The frame assembly 34 may extend along a longitudinal direction 36 between a forward end portion 38 and an aft end portion 40. The frame assembly 34 may also extend along a lateral direction 42 (FIG. 2) between a first side portion 44 and a second side portion 46. In this respect, the frame assembly 34 generally includes a plurality of structural frame members 48, such as beams, bars, and/or the like, configured to support or couple to a plurality of components. Additionally, a plurality of wheel assemblies 50 may be coupled to the frame assembly 34, such as a set of centrally located wheel assemblies 50 and a set of front pivoting wheel assemblies 50, to facilitate towing the implement 14 in the direction of travel 18.

The frame assembly 34 may be configured to support a plurality of ground-engaging tools 52, such as a plurality of shanks, disk blades, levelers (e.g., leveling blades), basket assemblies, tines, spikes, and/or the like. For example, the frame assembly 34 may be configured to support various gangs of disc blades 54, a plurality of ground-engaging shanks 56, a plurality of levelers 58 (e.g., leveling blades), and a plurality of crumbler wheels or basket assemblies 60. However, in alternative embodiments, the frame assembly 34 may be configured to support any other suitable ground-engaging tools 52 and/or a combination of ground-engaging tools 52. In several embodiments, the various ground-engaging tools 52 may be configured to perform a tillage operation or any other suitable ground-engaging operation across the field 16 along which the implement 14 is being towed. It should be understood that, in addition to being towed by the work vehicle 12, the implement 14 may also be a semi-mounted implement connected to the work vehicle 12 via a two-point hitch or the implement 14 may be a fully mounted implement (e.g., mounted the work vehicle's three-point hitch).

With further reference to FIGS. 2-4, various portions of the frame assembly 34 may be adjusted relative to one another. For example, a levelness of the frame assembly 34 may be generally defined by a pitch of the frame assembly 34 (e.g., as indicated by arrow 62 in FIG. 2) and/or a roll (e.g., as indicated by arrow 64 in FIG. 2) of the frame assembly 34. In general, the pitch 41 of the frame assembly 34 may be a differential in the heights of the forward end portion 38 and the aft end portion 40 of the frame assembly 34 in the longitudinal direction 36 of the implement 14. That is, the frame assembly 34 may be pitched when the one of the forward or aft end portions 38, 40 of the frame assembly 34 is closer to the ground than the other of forward or aft end portions 38, 40 of the frame assembly 34. Additionally, the roll 43 of the frame assembly 34 may be a differential in the heights of the first side portion 44 and the second side portion 46 of the frame assembly 34 in the lateral direction 42 of the implement 14. That is, the frame assembly 34 may be rolled when the one of the first side portion 44 and the second side portion 46 of the frame assembly 34 is closer to the ground than the other of the first side portion 44 and the second side portion 46 of the frame assembly 34.

In several examples, the frame assembly 34 may include one or more sections. As illustrated in FIG. 2, for example, the frame assembly 34 may include a main section 66 positioned centrally between the first side portion 44 and the second side portion 46 of the frame assembly 34. The frame assembly 34 may also include a first wing section 68 positioned proximate to the first side portion 44 of the frame assembly 34. Similarly, the frame assembly 34 may also include a second wing section 70 positioned proximate to the second side portion 46 of the frame assembly 34. The first and second wing sections 68, 70 may be pivotally coupled to the main section 66 of the frame assembly 34. In this respect, the first and second wing sections 68, 70 may be configured to fold up relative to the main section 66 to reduce the lateral width of the implement 14 to permit, for example, storage or transportation of the implement 14 on a road. It will be appreciated that the frame assembly 34 may include any suitable number of wing sections.

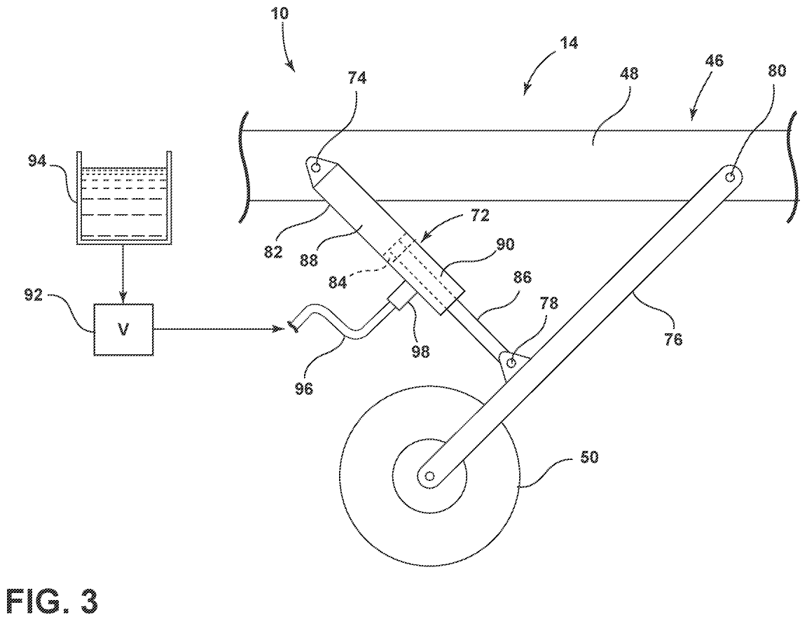

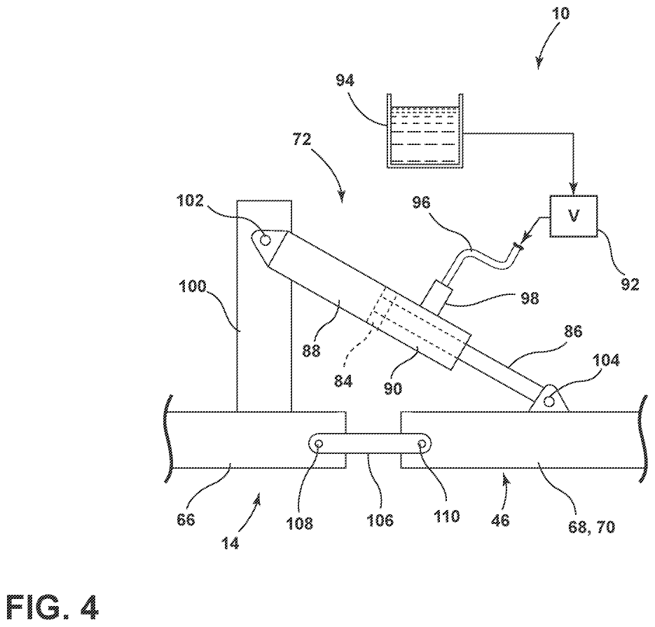

In various examples, one or more implement actuators 72 may be configured to adjust the relative positioning of one or more components of the implement 14 and or the work vehicle 12 to allow the pitch and/or the roll of the frame assembly 34 to be adjusted. Additionally or alternatively, the implement actuators 72 may be used for adjusting one section of the frame assembly 34 relative to another. For example, FIG. 3 illustrates a side view of an implement actuator 72 configured for adjusting a position of one of the wheel assemblies 50 of the implement 14 relative to the frame assembly 34 of the implement 14, and FIG. 4 illustrates a side view of an implement actuator 72 configured for adjusting a position of one of the wing sections 68, 70 of the frame assembly 34 relative to the main section 66 of the frame assembly 34. It will be appreciated that the implement 14 can include one or more implement actuators 72 in any other location to adjust the relative positioning of one or more components of the implement 14 and or the work vehicle 12 without departing from the teachings provided herein. Additionally, it will be appreciated that while the implement actuator 72 in the illustrated examples of FIGS. 3 and 4 corresponds to a hydraulic cylinder, the implement actuator 72 may also correspond to any other suitable actuator, such as a pneumatic actuator, linear actuator, a solenoid, and/or any other practicable assembly.

Referring further to FIG. 3, in several examples, the wheel assemblies 50 may be configured to be pivotable or otherwise moveable relative to the frame assembly 34 of the implement 14 to permit one or more associated implement actuators 72 to adjust the position of the wheel assemblies 50 relative to the frame assembly 34. In such examples, the position of the wheel assemblies 50 relative to the frame assembly 34 may be adjusted to adjust the orientation of the frame assembly 34 in the lateral direction 42.

As shown in FIG. 3, in various examples, one end portion of the implement actuator 72 may be pivotably coupled to one of the frame members 48 of the frame assembly 34 at a pivot joint 74. Similarly, an opposed end portion of the implement actuator 72 may also be coupled to a pivot arm 76 of the implement 14 at a pivot joint 78. As shown, the pivot arm 76 may, in turn, pivotably couple the wheel assembly 50 to the corresponding frame member 48 of the frame assembly 34 at a pivot joint 80. As such, the pivot joints 74, 78, 80 may allow relative pivotable movement between the frame member 48, the pivot arm 76, and the implement actuator 72, thereby allowing the position of the associated wheel assembly 50 relative to the frame assembly 34 to be adjusted. However, it will be appreciated that the wheel assemblies 50 may be adjustably coupled to the frame assembly 34 in any suitable manner that permits the implement actuator 72 to move the wheel assemblies 50 relative to the frame assembly 34. Furthermore, the implement actuator 72 may be configured to move any of the wheel assemblies 50 on the implement 14 relative to the frame assembly 34.

In several examples, the implement actuator 72 may correspond to a suitable hydraulic actuator. In such examples, the implement actuator 72 may include both a cylinder 82 configured to house a piston 84 and a rod 86 coupled to the piston 84 that extends outwardly from the cylinder 82. Additionally, the implement actuator 72 may include a piston-side chamber 88 and a rod-side chamber 90 defined within the cylinder 82. As is generally understood, by regulating the pressure of the fluid supplied to one or both of the cylinder chambers 88, 90, the actuation of the rod 86 may be controlled. As shown in FIG. 3, the end portion of the rod 86 can be coupled to the arm 76 at the pivot joint 78, while the cylinder 82 can be coupled to the frame member 48 at the opposed pivot joint 74. However, the end portion of the rod 86 may be coupled to the frame member 48 at pivot joint 74 while the cylinder 82 may be coupled to the arm 76 at the pivot joint 78 without departing from the teachings provided herein.

In several examples, a suitable pressure regulating valve 92 (PRV) (e.g., a solenoid-activated valve or a manually operated valve) may be configured to regulate a supply of fluid (e.g., hydraulic fluid or air from a suitable fluid source or tank 94) being supplied to the implement actuator 72. As shown in FIG. 3, the PRV 92 may be in fluid communication with the rod-side chamber 90 of the implement actuator 72. In this respect, a fluid conduit 96, such as a hose, fluidly couples the PRV 92 to a fitting 98 on the cylinder 82. As such, the PRV 92 may regulate the supply of fluid to the rod-side chamber 90. It will be appreciated that, in alternate examples, the PRV 92 may be in fluid communication with the piston-side chamber 88 to regulate the supply of fluid thereto. Alternatively, a pair of PRVs 92 may be in respective fluid communication with one of the chambers 88, 90 of the implement actuator 72.

Referring now to FIG. 4, as indicated above, the wing sections 68, 70 of the frame assembly 34 may be configured to be pivotable relative to the main section 66 of the frame assembly 34. As such, one or more implement actuators 72 may be used to adjust the position of the first and/or second wing sections 68, 70 relative to the main section 66, which may be utilized to adjust a roll angle of the implement 14.

As shown in FIG. 4, to allow for such adjustments, one or more implement actuators 72 are coupled between each wing section 68, 70, and the main section 66 of the frame assembly 34. In general, the actuators 220 described with reference to FIG. 4 may be configured the same as or similar to the implement actuator 72 described above with reference to FIG. 3. For instance, in several examples, the cylinder 82 of the implement actuator 72 may be pivotably coupled to a post 100 extending from the main section 66 of the frame assembly 34 at pivot joint 102. Similarly, the rod 86 of the implement actuator 72 may be pivotably coupled to the corresponding wing section 68, 70 at a pivot joint 104. Additionally, in various examples, a link 106 of the implement 14 may be pivotably coupled between the corresponding wing sections 68, 70, and the main section 66 at pivot joints 108, 110, respectively. As such, the pivot joints 102, 104, 108, 110 may allow relative pivotable movement between the main section 66, the corresponding wing section 68, 70, and the implement actuator 72. However, in alternative examples, the cylinder 82 of the implement actuator 72 may be pivotably coupled to the corresponding wing section 68, 70 at the pivot joint 104, while the rod 86 of the implement actuator 72 may pivotably couple to the post 100 at the pivot joint 102.

It will be appreciated that the configuration of the agricultural machine 10 described above and shown in FIGS. 1-4 is provided only to place the present subject matter in an example field of use. Thus, it will be appreciated that the present subject matter may be readily adaptable to any manner of machine configurations, including any suitable work vehicle configuration and/or implement configuration. For example, in an alternative example of the work vehicle 12, a separate frame or chassis may be provided to which the power source 30, transmission, and drive axle assembly are coupled, a configuration common in smaller tractors. Still other configurations may use an articulated chassis to steer the work vehicle 12 or rely on tires/wheels in lieu of the track assemblies 20, 22. Similarly, as indicated above, the frame assembly 34 of the implement 14 may be configured to support any other suitable combination of type of ground-engaging tools 52.

Furthermore, in accordance with aspects of the present subject matter, the agricultural machine 10 may include one or more field sensors 112 coupled thereto and/or supported thereon. Each field sensor 112 may, for example, be configured to capture data indicative of one or more conditions of the field 16 along which the machine 10 is being traversed. For example, in several examples, the field sensor 112 may be used to collect data associated with one or more conditions of the field 16, such as residue size, size distribution of the residue (the number or amount of residue that falls into each size category), and/or any other suitable condition that affects the performance of the implement 14.

In several examples, the one or more field sensors 112 may be provided in operative association with the agricultural machine 10 such that the one or more field sensors 112 have a field of view directed towards a portion(s) of the field adjacent to the work vehicle 12 and/or the implement 14, such as a portion(s) of the field disposed in front of, behind, and/or along one or both of the side portions of the work vehicle 12 and/or the implement 14. For example, as shown in FIG. 1, in various examples, one or more field sensors 112 may be provided at a forward end portion 114 of the work vehicle 12 to allow the one or more field sensors 112 to capture images and related data of a section of the field disposed in front of the work vehicle 12. Such forward-located field sensors 112 may allow pre-tillage images of the field to be captured for monitoring or determining surface conditions of the field prior to the performance of a tillage operation. Similarly, as shown in FIG. 1, one or more field sensors 112 may be provided at or adjacent to an aft end portion 40 of the implement 14 to allow the one or more field sensors 112 to capture images and related data of a section of the field disposed behind the implement 14. Such aft-located field sensors 112 may allow post-tillage images of the field to be captured for monitoring or determining surface conditions of the field after the performance of a tillage operation.

It will be appreciated that, in alternative cases, the one or more field sensors 112 may be installed at any other suitable location(s) on the work vehicle 12 and/or the implement 14. In addition, it will be appreciated that, in some cases, the agricultural machine 10 may only include a single field sensor 112 mounted on either the work vehicle 12 or the implement 14 or may include more than two field sensors 112 mounted on the work vehicle 12 and/or the implement 14. Moreover, it will be appreciated that each field sensor 112 may be configured to be mounted or otherwise supported relative to a portion of the agricultural machine 10 using any suitable mounting/support structure. For instance, each field sensor 112 may be directly or indirectly mounted to a portion of the work vehicle 12 and/or the implement 14. For instance, a suitable mounting structure (e.g., mounting arms, brackets, trays, etc.) may be used to support each field sensor 112 in front of the vehicle 12 or behind the implement 14 (e.g., in a cantilevered arrangement) to allow the one or more field sensors 112 to obtain the desired field of view, including the desired orientation of the device's field of view relative to the field (e.g., a straight-down view oriented generally perpendicular to the surface of the field).

In general, the one or more field sensors 112 may correspond to any suitable devices or other assembly configured to capture images. For instance, in several examples, the one or more field sensors 112 may correspond to a camera assembly. In such examples, the camera assembly may be used to capture images of the field and/or an area proximate thereto. In various examples, the camera assembly may include a pair of lenses and a pair of image sensors for capturing two-dimensional images. Additionally, by simultaneously capturing an image of the same portion of the field with each image sensor, the separate images can be combined, compared, and/or otherwise processed to extract three-dimensional information about such a portion of the field. For example, by comparing the images captured by each camera, a depth image can be generated that allows the scene depth to be determined (e.g., relative to the camera) at each corresponding pixel location within the imaged portion of the field. As a result, the relative depth of specific features or points within the field may be determined. It will be appreciated that, in addition to a camera assembly or as an alternative thereto, the agricultural machine 10 may include any other suitable type of field sensor 112. In several examples, the field sensor 112 may additionally or alternatively correspond to a radio detection and ranging (RADAR) sensor system, an ultrasonic sensor, a Light Detection and Ranging (LIDAR) sensor, a sound navigation and ranging (SONAR) sensor, a vision-based sensor, and/or any other practicable sensor.

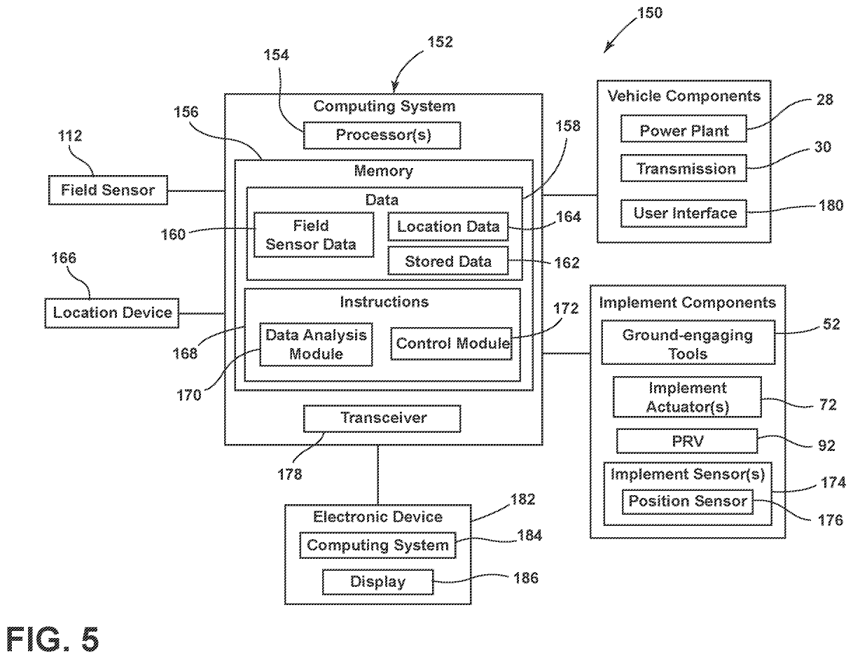

Referring now to FIG. 5, a schematic view of a system 150 for an agricultural machine 10 is illustrated in accordance with aspects of the present subject matter. In several examples, the disclosed system 150 is configured for detecting one or more conditions of the field 16, such as residue size, size distribution of the residue (the number or amount of residue that falls into each size category), and/or any other suitable condition that affects the performance of the implement 14. In turn, the system 150 may perform one or more mitigating operations such that various negative conditions that may occur during a tillage operation may be mitigated. The system 150 will generally be described herein with reference to the agricultural machine 10 described above with reference to FIGS. 1-4. However, the disclosed system 150 may generally be utilized with agricultural machines having any other suitable machine configuration.

As shown in FIG. 5, the system 150 may include one or more field sensors 112 configured to capture data indicative of various conditions of a region of the field 16 disposed adjacent to the work vehicle 12 and or the implement 14. The system 150 may further include a computing system 152 communicatively coupled to the field sensor 112. In several examples, the computing system 152 may be configured to receive and process the data captured by the field sensor 112. For instance, the computing system 152 may be configured to receive data indicative of one or more conditions of the field 16, such as residue size, size distribution of the residue (the number or amount of residue that falls into each size category), and/or any other suitable condition that affects the performance of the implement 14. In turn, the computing system 152 may determine an implement levelness of the frame assembly 34, and/or portions thereof, based in part on the residue size, size distribution of the residue (the number or amount of residue that falls into each size category), and/or any other suitable condition that affects the performance of the implement 14. In some cases, as the residue size and/or the size distribution of the residue (the number or amount of residue that falls into each size category) varies, the implement levelness of the frame assembly 34 may be adjusted through the one or more implement actuators 72 to process the residue correctly by altering the working depth of the ground-engaging tools 52 to slice through the residue. Based on the implement levelness, the system 150 can determine an implement actuator model that defines a position of the one or more implement actuators 72 in order for the frame assembly 34 to be placed at the defined implement levelness.

In various examples, the implement levelness may be compared to a levelness range defined by a lower threshold and an upper threshold, which may set to mitigate seedbed levelness issues and/or for any other purpose. In some instances, the system 150 may compare the implement levelness to the levelness range to ensure that the defined implement levelness does not exceed the limits for seedbed floor levelness. In some cases, when the determined implement levelness is within the levelness range, the system 150 can define an implement actuator model that correlates to the implement levelness and, in turn, actuate the one or more implement actuators 72 to modify the position of one or more components of the frame assembly 34 (e.g., an angle and position of the implement 14 relative to the ground and/or the vehicle 12) based on the implement actuator model. When the determined implement levelness deviates from the levelness range, the implement actuator model is set to a maximum offset angle when the implement actuator model exceeds an upper threshold of the defined levelness range. Likewise, the system 150 can set the implement actuator model to a minimum offset angle when the implement actuator model is less than a lower threshold of the defined levelness range. In addition, the system 150 can continue to observe the potential for/of plugging of the implement 14 based at least partially on the frame being placed in the implement actuator model.

In general, the computing system 152 may include any suitable processor-based device, such as a computing device or any suitable combination of computing devices. Thus, in several examples, the computing system 152 may include one or more processors 154 and associated memory 156 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 156 of the computing system 152 may generally comprise memory element(s) including, but not limited to, a computer-readable medium (e.g., random access memory (RAM)), a computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 156 may generally be configured to store suitable computer-readable instructions that, when implemented by the processors 154, configure the computing system 152 to perform various computer-implemented functions, such as one or more aspects of the data processing algorithm(s) and/or related method(s) described below. In addition, the computing system 152 may also include various other suitable components, such as a communications circuit or module, one or more input/output channels, a data/control bus, and/or the like.

It will be appreciated that, in several examples, the computing system 152 may correspond to an existing controller of the agricultural machine 10, or the computing system 152 may correspond to one or more separate processing devices. For instance, in some examples, the computing system 152 may form all or part of a separate plug-in module or computing device(s) that is installed relative to the work vehicle 12 or implement 14 to allow for the disclosed system 150 and method to be implemented without requiring additional software to be uploaded onto existing control devices of the work vehicle 12 or implement 14.

In several examples, the memory 156 of the computing system 152 may include one or more databases 158 for storing information received and/or generated by the computing system 152. For instance, as shown in FIG. 5, the memory 156 may include a field sensor database 160 storing data associated with the data captured by the field sensor 112, including the captured data and/or data deriving from the captured data (e.g., disparity maps, depth images generated based at least partially on the captured data by the field sensor 112, etc.). Additionally, the memory 156 may include a stored data database 162 storing data acquired from various sources. For instance, the stored data can include a residue map that is generated through any method, such as with a previous agricultural operation, user-entered information, from the one or more field sensor 112, and/or other systems.

Additionally or alternatively, as shown in FIG. 5, the memory 156 may also include a location database 164, which may be configured to store location data generated by a location device 166 that is stored in association with the data for later use in geo-locating the data relative to the field 16. In some examples, the location device 166 may be configured as a satellite navigation positioning device (e.g. a GPS, a Galileo positioning system, a Global Navigation satellite system (GLONASS), a BeiDou Satellite Navigation and Positioning system, a dead reckoning device, and/or the like) to determine the location of the machine 10.

Moreover, as shown in FIG. 5, in several examples, the memory 156 may also include instructions 168 that may be executed by the processor 154 to implement a data analysis module 170. In general, the data analysis module 170 may be configured to process/analyze the captured data received from the field sensor 112, the stored data, and/or the location data. In various examples, the data analysis module 170 may be configured to execute one or more data processing algorithms to determine an implement levelness. In turn, the computing system 152 may determine an implement actuator model based in part on the determined implement levelness and a levelness range. In some cases, as the residue size and/or the size distribution of the residue varies, the implement actuator model may be adjusted through the implement actuators 72.

Referring still to FIG. 5, in some examples, the instructions 168 stored within the memory 156 of the computing system 152 may also be executed by the processor 154 to implement a control module 172. In general, the control module 172 may be configured to electronically control the operation of one or more components of the agricultural machine 10. For instance, in several examples, the control module 172 may be configured to control the operation of the agricultural machine 10 and/or the agricultural implement 14 based at least partially on the implement actuator model. Such control may include altering a position of the frame assembly 34 (e.g., a pitch and/or a roll of the frame assembly 34), which in turn can alter a portion of one or more of the ground-engaging tools 52 of the implement 14 (e.g., the disc blades 54, shanks 56, levelers 58 (e.g., leveling blades), and/or basket assemblies 60) to proactively or reactively adjust the operation of the implement 14 in view of the monitored surface condition(s).

In instances in which one or more operating parameters are adjusted, the actuation of one or more implement components may be based at least partially on data from one or more implement sensors 174. For example, the one or more implement sensors 174 can include a position sensor 176 operably coupled with the implement 14 may detect the change in position. In some examples, the position sensor 176 may be configured as an inertial measurement unit (IMU) that measures a specific force, angular rate, and/or an orientation of the implement 14 using a combination of accelerometers, gyroscopes, magnetometers, and/or any other practicable device. The accelerometer may correspond to one or more multi-axis accelerometers (e.g., one or more two-axis or three-axis accelerometers) such that the accelerometer may be configured to monitor the movement of the implement 14 in multiple directions, such as by sensing the implement acceleration along three different axes. It will be appreciated, however, that the accelerometer may generally correspond to any suitable type of accelerometer without departing from the teachings provided herein.

In several examples, the computing system 152 may also include a transceiver 178 to allow for the computing system 152 to communicate with various components. For instance, one or more communicative links or interfaces (e.g., one or more data buses) may be provided between the transceiver 178 and a user interface 180, an electronic device 182, and/or any other device.

The user interface 180 may be housed within the cab 25 (FIG. 1) of the work vehicle 12 or at any other suitable location. The user interface 180 may be configured to provide feedback to the operator of the agricultural machine 10. Thus, the user interface 180 may include one or more feedback devices, such as display screens, speakers, warning lights, and/or the like, which are configured to communicate such feedback. In addition, some examples of the user interface 180 may include one or more touchscreens, keypads, touchpads, knobs, buttons, sliders, switches, mice, microphones, and/or the like, which are configured to receive user inputs from the operator.

The electronic device 182 may include a variety of computing systems 184 including a processor and memory and/or a display 186 for displaying information to a user. For instance, the electronic device 182 may display one or more user interfaces and may be capable of receiving remote user input. In addition, the electronic device 182 may provide feedback information, such as visual, audible, and tactile alerts, and/or allow the operator to alter or adjust one or more components of the agricultural machine 10 through the usage of the remote electronic device 182. For example, the electronic device 182 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

It will be appreciated that, although the various control functions and/or actions will generally be described herein as being executed by the computing system 152, one or more of such control functions/actions (or portions thereof) may be executed by a separate computing system or may be distributed across two or more computing systems (including, for example, the computing system 152 and a separate computing system). For instance, in some examples, the computing system 152 may be configured to acquire data from the field sensor 112 for subsequent processing and/or analysis by a separate computing system (e.g., a computing system associated with a remote server). In other examples, the computing system 152 may be configured to execute the data analysis module 170 to determine and/or monitor one or more surface conditions within the field 16, while a separate computing system (e.g., a vehicle computing system 152 associated with the agricultural machine 10) may be configured to execute the control module 172 to control the operation of the agricultural machine 10 based at least partially on data and/or instructions 168 transmitted from the computing system 152 that are associated with the monitored surface condition(s).

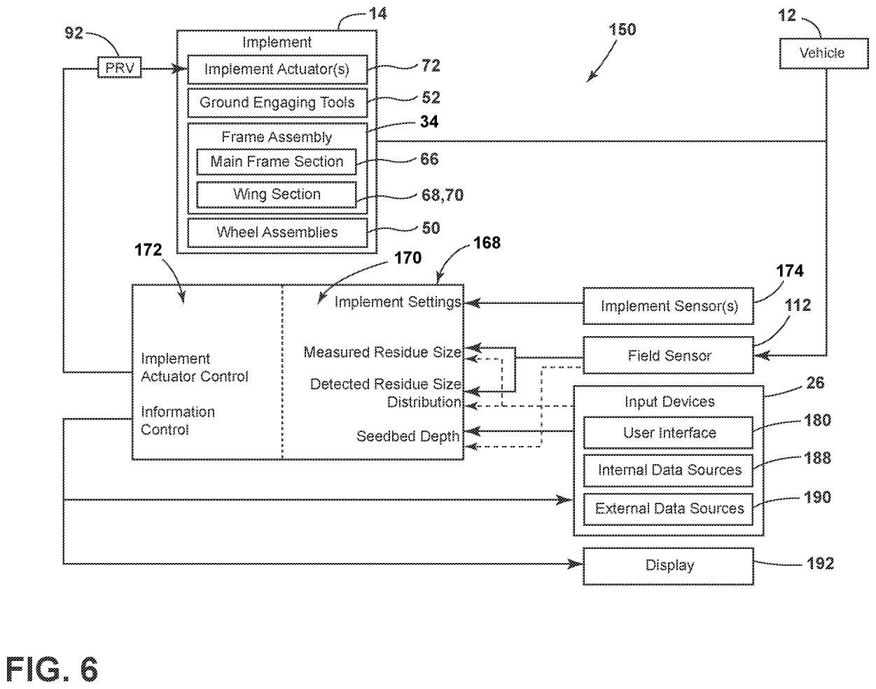

Referring to FIG. 6, various components of the system 150 are illustrated in accordance with various aspects of the present disclosure. As shown, the data analysis module 170 may receive data from various components of the system 150, such as via the field sensor 112, the implement sensors 174, and/or one or more input devices 26. In various cases, the one or more input devices 26 can include one or more user interfaces 180 for allowing operator inputs to be provided to the computing system 152 (e.g., buttons, knobs, dials, levers, joysticks, touch screens, and/or the like), one or more other internal data sources 188 associated with the agricultural machine 10 (e.g., other devices, stored data, databases, etc.), one or more external data sources 190 (e.g., a remote computing device or server), and/or any other suitable input devices 26.

Based at least partially on the received data, the control module 172 can alter or manipulate various components of the implement 14, such as the implement actuator 72. As provided herein, the data analysis module 170 can receive various inputs and calculate an implement levelness based at least in part on a residue size, a size distribution of the residue, and/or a seedbed floor. In various examples, the implement levelness may be compared to a levelness range defined by a lower threshold and an upper threshold, which may mitigate seedbed levelness issues. In some cases, when the determined implement levelness is within the levelness range, the system 150 can define an implement actuator model that correlates to the implement levelness and, in turn, actuate the one or more implement actuators 72 to modify the position of one or more components of the frame assembly 34 causing an angle and position of the implement relative to the ground and/or the vehicle 12. When the determined implement levelness deviates from the levelness range, the system 150 can set the implement actuator model to the upper threshold if the determined implement levelness is above the upper threshold. Likewise, the system 150 can set the implement actuator model to the lower threshold if the determined implement levelness is below the lower threshold. Therefore, the system 150 may compare the implement actuator model to the levelness range to ensure that the defined implement levelness does not exceed the limits for seedbed floor levelness. In some cases, the system 150 may use a look-up table, one or more algorithms, and/or any other processes to correlate the implement levelness to the implement actuator model.

In some cases, the implement actuators 72 may be configured as one or more suitable hydraulic actuators. In such cases, the control module 172 may be configured to electronically control the operation of a PRV 92 to adjust the fluid pressure supplied within the implement actuator 72. For instance, the computing system 152 may be configured to control the operation of the PRV 92 such that the fluid pressure supplied to the rod-side chamber 90 (FIGS. 3 and 4) of the implement actuator 72 is increased or decreased when an implement actuator model is to be altered. In examples in which the implement actuator is operably coupled with the wheel assemblies 50 of the implement 14, increasing the fluid pressure within the rod-side chamber 90 (FIGS. 3 and 4) may cause the rod 86 (FIGS. 3 and 4) to retract into the cylinder 82 (FIGS. 3 and 4), thereby moving the wheel assemblies 50 closer to the frame assembly 34. Conversely, decreasing the fluid pressure within the rod-side chamber 90 may cause the rod 86 (FIGS. 3 and 4) to extend further from the cylinder 82 (FIGS. 3 and 4), thereby moving the wheel assemblies 50 farther away to the frame assembly 34. Pivoting the wheel assembly 50 upward relative to the frame assembly 34 (e.g., if a portion of the frame assembly 34 proximate to that wheel assembly 50 is farther from the ground than the portion of the frame assembly 34 proximate to another of wheel assemblies 50) or pivoting the wheel assemblies 50 downward relative to the frame assembly 34 (e.g., if a portion of the frame assembly 34 proximate to that wheel assembly 50 is closer from the ground than the portion of the frame assembly 34 proximate to another wheel assembly 50) may, for example, allow for a corresponding alteration in the roll of the frame assembly 34. Additionally or alternatively, pivoting each of the wheel assemblies 50 upward relative to the frame assembly 34 or pivoting each of the wheel assemblies 50 downward relative to the frame assembly 34 may allow for a corresponding alteration of the roll of the frame assembly 34.

Similarly, the control module 172 may be configured to control the operation of the implement actuator 72 to adjust the position of a wing section 68, 70 of the frame assembly 34 relative to the main section 66. As such, increasing the fluid pressure within the rod-side chamber 90 (FIGS. 3 and 4) may retract the rod 86 (FIGS. 3 and 4) into the cylinder 82, thereby pivoting the wing section 68, 70 upward (i.e., away from the ground) relative to the main section 66. Conversely, decreasing the fluid pressure within the rod-side chamber 90 (FIGS. 3 and 4) may extend the rod 86 (FIGS. 3 and 4) farther outward from the cylinder 82 (FIGS. 3 and 4), thereby pivoting the wing section 68, 70 downward (i.e., toward the ground) relative to the main section 66. Pivoting the wing section 68, 70 upward relative to the main section 66 (e.g., if the wing section 68, 70 is closer to the ground than the main section 66) or pivoting the wing section 68, 70 upward relative to the main section 66 (e.g., if the wing section 68, 70 is farther from the ground than the main section 66) may, for example, allow for a corresponding reduction in the roll of the frame assembly 34, thereby reorienting the frame assembly 34 across the lateral direction 42 of the implement 14.

Additionally or alternatively, the control module 172 may generate display instructions 168 for one or more displays 192, which may be incorporated within the user interface 180 and/or be remote from the user interface 180. For instance, the display 192 may illustrate information related to at least one of a residue size, a size distribution of the residue (the number or amount of residue that falls into each size category), a defined implement levelness, the defined implement levelness relative to a defined levelness range, an implement actuator model, and/or any other information.

During operation, data may be sequentially collected by the field sensor 112 and/or the implement sensors 174, which may be provided as subsequent inputs to the data analysis module 170 so that additional alterations to implement actuators 72 may be made, if needed. In addition, the data analysis module 170 may alter one or more subsequent outputs based at least partially on a result of a previous instruction. As such, the data analysis module 170 may learn from the results of previous instructions to alter subsequent instructions.

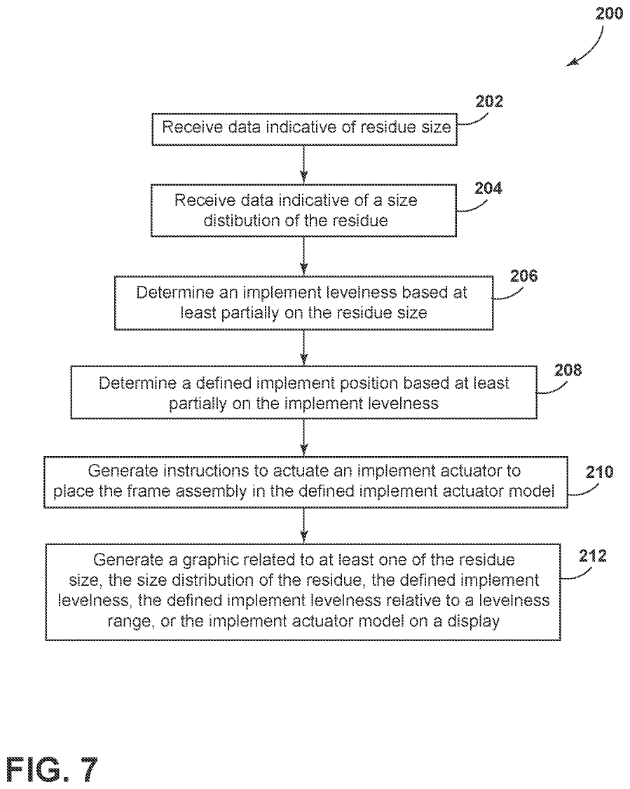

Referring now to FIG. 7, a flow diagram of a method 200 for operating an agricultural system is illustrated in accordance with aspects of the present subject matter. In general, the method 200 will be described herein with reference to the agricultural machine 10 shown in FIGS. 1-4 and the various system components shown in FIGS. 5 and 6. However, it will be appreciated that the disclosed method 200 may be implemented with agricultural machines having any other suitable machine configurations and/or within systems having any other suitable system configuration without deviating from the present disclosure. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As illustrated, at (202), the method 200 can include receiving data indicative of residue size. Additionally or alternatively, at (204), the method 200 can include receiving data indicative of a size distribution of the residue. In some cases, the residue size and/or the size distribution data may be received from the one or more field sensors and/or one or more input devices.

At (206), the method 200 can include determining an implement levelness based at least partially on the residue size with a computing system. Additionally or alternatively, the implement levelness can be based at least partially on the residue size distribution.

At (208), the method 200 can include determining an implement actuator model based at least partially on the implement levelness with a computing system. As provided herein, the implement actuator model can be a defined position for each of the one or more implement actuators to place the implement in the defined implement levelness.

In various examples, the implement levelness may be compared to a levelness range defined by a lower threshold and an upper threshold, which may correspond to a seedbed of the field. In some instances, the method can include comparing the implement actuator model to the levelness range to ensure that the defined implement levelness does not exceed the limits for seedbed floor levelness. In some cases, when the determined implement levelness is within the levelness range, the system can define an implement actuator model that correlates to the implement levelness and, in turn, actuate the one or more implement actuators to modify the position of one or more components of the frame assembly (e.g., an angle and position of the implement relative to the ground and/or the vehicle). When the determined implement levelness deviates from the levelness range, the implement actuator model may be set to a maximum offset angle when the implement actuator model exceeds an upper threshold of the defined levelness range. Likewise, the implement actuator model may be set to a minimum offset angle when the implement actuator model is less than a lower threshold of the defined levelness range. In addition, the system can continue to observe the potential for/of plugging of the implement based at least partially on the frame being placed in the implement actuator model.

At (210), the method 200 can include generating instructions to actuate an implement actuator to place the frame assembly in the implement actuator model with the computing system. Additionally or alternatively, at (212), the method 200 can include generating a graphic related to at least one of the residue size, the size distribution of the residue, a defined implement levelness, the defined implement levelness relative to a defined levelness range, or the implement actuator model on a display with the computing system.

In various examples, the method 200 may implement machine learning methods and algorithms that utilize one or several machine learning techniques including, for example, decision tree learning, including, for example, random forest or conditional inference trees methods, neural networks, support vector vehicles, clustering, and Bayesian networks. These algorithms can include computer-executable code that can be retrieved by the computing system and/or through a network/cloud and may be used to evaluate and update the boom deflection model. In some instances, the machine learning engine may allow for changes to the boom deflection model to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the computing system, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural system comprising:
an implement including a frame assembly;
one or more ground-engaging tools operably supported by the frame assembly;
an implement actuator operably coupled with the frame assembly and configured to alter a position of one or more frame members of the frame assembly relative to a ground surface; and
a computing system communicatively coupled to the implement actuator, the computing system including a processor and associated memory, the memory storing instructions that, when implemented by the processor, configure the computing system to:
receive data indicative of residue size;
determine an implement levelness based at least partially on the residue size; and
determine an implement actuator model based at least partially on the implement levelness.

2. The agricultural system of claim 1, wherein the computing system is further configured to:
receive data indicative of a size distribution of the residue.

3. The agricultural system of claim 2, wherein the implement actuator model is further based at least partially on the size distribution of the residue.

4. The agricultural system of claim 1, further comprising:
a field sensor configured to capture the data indicative of residue size.

5. The agricultural system of claim 2, wherein the implement actuator model is further based at least partially on a defined levelness range.

6. The agricultural system of claim 5, wherein the defined levelness range is based at least partially on a seedbed levelness for a field.

7. The agricultural system of claim 5, wherein the implement actuator model is correlated with the defined levelness range, and wherein the implement actuator model is set to a maximum offset angle when the implement actuator model exceeds an upper threshold of the defined levelness range.

8. The agricultural system of claim 5, wherein the implement actuator model is correlated with the defined levelness range, and wherein the implement actuator model is set to a minimum offset angle when the implement actuator model is less than a lower threshold of the defined levelness range.

9. The agricultural system of claim 2, further comprising:
a location device, wherein at least one of the residue size or the size distribution of the residue is based at least partially on a position of the implement within a field, as determined by the location device, and a correlated residue map.

10. The agricultural system of claim 1, further comprising:
a position sensor operably coupled with the implement actuator; the position sensor is configured to capture data indicative of a detected position of the frame assembly relative to the ground.

11. The agricultural system of claim 2, further comprising:
a display operably coupled with the computing system, the computing system configured to illustrate information related to at least one of the residue size, the size distribution of the residue, a defined implement levelness, the defined implement levelness relative to a defined levelness range, or the implement actuator model.

12. The agricultural system of claim 1, further comprising:
an implement sensor configured to detect one or more implement settings associated with the implement.

13. A method for operating an agricultural system, the method comprising:
receiving, from one or more field sensors, data indicative of residue size;
determining, with a computing system, an implement levelness based at least partially on the residue size; and
determining, with a computing system, an implement actuator model based at least partially on the implement levelness.

14. The method of claim 13, further comprising:
receiving, from one or more field sensors, data indicative of a size distribution of the residue, wherein the implement levelness is based at least partially on the residue size distribution.

15. The method of claim 14, wherein the implement actuator model is based at least partially on a defined levelness range, the defined levelness range corresponding to a seedbed of the field.

16. The method of claim 13, further comprising:
generating, with the computing system, instructions to actuate an implement actuator to place a frame assembly in the implement actuator model.

17. The method of claim 13, further comprising:
generating, with the computing system, a graphic related to at least one of the residue size, a size distribution of residue, a defined implement levelness, the defined implement levelness relative to a defined levelness range, or the implement actuator model on a display.

18. An agricultural system comprising:
a frame assembly;
one or more ground-engaging tools operably supported by the frame assembly;
an implement actuator operably coupled with the frame assembly and configured to alter a position of one or more frame members of the frame assembly relative to a ground surface; and
a computing system communicatively coupled to the implement actuator, the computing system including a processor and associated memory, the memory storing instructions that, when implemented by the processor, configure the computing system to:
receive data indicative of a size distribution of residue;
determine an implement levelness based at least partially on the size distribution of the residue; and
determine an implement actuator model based at least partially on the implement levelness.

19. The agricultural system of claim 18, further comprising:
a field sensor configured to capture the data indicative of residue size.

20. The agricultural system of claim 19, wherein the implement actuator model is further based at least partially on a defined levelness range.
